(19) United States
(12) Patent Application Publication
(10) Pub. No.: US 2007/0229425 A1
(43) Pub. Date: Oct. 4, 2007

(54) Image information transmitting device and image information receiving device

(75) Inventor: Shoji Nagao, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/603,212

(22) Filed: Nov. 22, 2006

(30) Foreign Application Priority Data
Mar. 30, 2006 (JP) JP2006-094118

(51) Int. Cl. G09G 3/36

(52) U.S. Cl. 345/89

(57) ABSTRACT

To provide a technology capable of transmitting image information at a high speed under the same physical conditions as those in the prior arts. An image information transmitting method of the present invention includes replacing, in data with a plurality of gradations that form image information, high-order data with low-order data, thinning out the data with the plurality of gradations that form the image information by deleting the low-order data, and consecutively outputting the post-thinning-out image information or the post-replacing image information. Further, an image information receiving method of the present invention includes consecutively receiving post-replacing image information or post-thinning-out image information, extracting the low-order data from the post-replacing image information, supplementing the low-order data extracted from the post-replacing image information to the post-thinning-out image information received after the post-replacing image information, replacing at least part of the high-order data of the post-thinning-out image information received just before the post-replacing image information with the low-order information in the way of being attached to the post-replacing image information, and outputting the post-supplementing image information and the post-replacing image information.

### BACKGROUND OF THE INVENTION

The present invention relates to a technology of transmitting image information by an information processing device (computer) and so on.

The information processing device such as a personal computer transmits image information obtained as a result of processing by an arithmetic processing unit to an image display device, wherein the image display device displays the image information. Especially, with spread of liquid crystal display devices over the recent years, such a case increases that digital data are transmitted between interfaces of the information processing device and the display device.

The interface with this liquid crystal display device has a basic configuration of including a power source, ground, four lines of timing signals (Hsync, Vsync, DataEnable, DotClock) and 18 through 24 lines of RGB image signals.

In the present technologies, the image transmission is conducted based on fast serial transmission by using a differential transmitting method such as LVDS (Low Voltage Differential Signaling) and TMDS (Transmission Minimized Differential Signaling). Then, it is desired from a highly refined structure etc of the display device to further increase a transmission speed. There is naturally, however, a limit on increasing the transmission speed due to physical problems such as impedance matching and a material of a transmission cable.

Further, the technology disclosed in the following Patent document 1 and 2 are given as the prior art related to the invention of the present application.

[Patent document 1] Japanese Patent Application Laid-Open Publication No. 8-179740

[Patent document 2] Japanese Patent No. 3018329

### SUMMARY OF THE INVENTION

As described above, if the increase in the transmission reaches its limit, it is considered to change a physical configuration (condition) such as doubling signal lines (transmission mediums) in order to attain further speedup.

For doubling the transmission speed, however, if simply the transmission mediums are doubled, there arises a problem, wherein the device is sized up, and so on.

Further, if the physical configuration is changed, such a problem occurs that the compatibility is deteriorated.

Such being the case, the present invention provides a technology capable of transmitting the image information at a high speed even under the same physical conditions as those in the prior arts.

The present invention adopts the following configurations in order to solve the problems.

Namely, an image information transmitting device of the present invention comprises a replacing unit replacing, in data with a plurality of gradations that form image information, at least part of high-order data with low-order data, a thinning-out unit thinning out the data with the plurality of gradations that form the image information by deleting the low-order data, and an output unit consecutively outputting the post-thinning-out image information or the post-replacing image information.

The replacing unit may replace, in the consecutive pieces of image information, the image information delimited at a predetermined cycle.

The image information transmitting device may comprise an identifying information generating unit generating a piece of identifying information for identifying the post-replacing image information, wherein the output unit may output the identifying information together with the image information.

The output unit may output the identifying information in place of the data with the plurality of gradations during a non-display period.

The output unit may output, in the case of outputting, as the image information, the data with the plurality of gradations and a timing signal, the identifying information in place of the timing signal during the non-display period.

Further, an image information receiving device of the present invention comprises a receiving unit consecutively receiving post-replacing image information obtained by replacing at least part of high-order data with low-order data in data with a plurality of gradations that form image information, or post-thinning-out image information obtained by thinning out the data with the plurality of gradations that form the image information by deleting the low-order data, a data extracting unit extracting the low-order data from the post-replacing image information, a supplementing unit supplementing the low-order data extracted from the post-replacing image information to the post-thinning-out image information received after the post-replacing image information, a re-replacing unit replacing at least part of the high-order data of the post-thinning-out image information received just before the post-replacing image information with the low-order information in the way of being attached to the post-replacing image information, and an output unit outputting the post-supplementing image information and the post-replacing image information.

The re-replacing unit may replace the image information delimited at a predetermined cycle in the consecutively-received image information.

The re-replacing unit may make the replacement on the basis of identifying information for identifying the post-replacing image information.

The receiving unit may receive the identifying information in place of the data with the plurality of gradations during a non-display period.

The receiving unit may receive, in the case of receiving, as the image information, the data with the plurality of gradations and a timing signal, the identifying information in place of the timing signal during the non-display period.

Moreover, an image information transmitting method of the present invention by which an image information transmitting device executes a step of replacing, in data with a plurality of gradations that form image information, at least part of high-order data with low-order data, a step of thinning out the data with the plurality of gradations that form the image information by deleting the low-order data, and a step of consecutively outputting the post-thinning-out image information or the post-replacing image information.

In the image information transmitting method, the data replacing step may include replacing, in the consecutive pieces of image information, the image information delimited at a predetermined cycle.

The image information transmitting method may further comprise a step of generating a piece of identifying information for identifying the post-replacing image information, wherein the image information outputting step may include outputting the identifying information together with the image information.

In the image information transmitting method, the image information outputting step may include outputting the identifying information in place of the data with the plurality of gradations during a non-display period.

In the image information transmitting method, the image information outputting step may include outputting, in the case of outputting, as the image information, the data with the plurality of gradations and a timing signal, the identifying information in place of the timing signal during the non-display period.

Still further, an image information receiving method of the present invention comprises a step of consecutively receiving post-replacing image information obtained by replacing at least part of high-order data with low-order data in data with a plurality of gradations that form image information, or post-thinning-out image information obtained by thinning out the data with the plurality of gradations that form the image information by deleting the low-order data, a step of extracting the low-order data from the post-replacing image information, a step of supplementing the low-order data extracted from the post-replacing image information to the post-thinning-out image information received after the post-replacing image information, a step of replacing at least part of the high-order data of the post-thinning-out image information received just before the post-replacing image information with the low-order information in the way of being attached to the post-replacing image information, and a step of outputting the post-supplementing image information and the post-replacing image information.

In the image information receiving method, the data replacing step may include replacing the image information delimited at a predetermined cycle in the consecutively-received image information.

In the image information receiving method, the replacement may be made based identifying information for identifying the post-replacing image information.

In the image information receiving method, the image information receiving step may include receiving the identifying information in place of the data with the plurality of gradations during a non-display period.

In the image information receiving method, the image information receiving step may include receiving, in the case of receiving, as the image information, the data with the plurality of gradations and a timing signal, the identifying information in place of the timing signal during the non-display period.

Further, the present invention may also be an image information transmitting program for making a computer execute the image information transmitting method. Still further, the present invention may also be an image information receiving program for making the computer execute the image information receiving method. Yet further, the present invention may also be a readable-by-computer storage medium stored with this program. The computer is made to read the program from the storage medium and to execute the program, whereby a function thereof can be provided.

Herein, the storage medium readable by the computer, etc. connotes a storage medium capable of storing information such as data, programs, etc. electrically, magnetically, optically, mechanically or by chemical action, which can be read from the computer. Among these storage mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the storage mediums fixed within the computer.

According to the present invention, there is provided the technology capable of transmitting the image information at the high speed even under the same physical conditions as those in the prior arts.

### BRIEF DESCRIPTION OF THE DRAWINGS

FIG. 1 is a schematic view of a computer including an image information transmitting device and an image information receiving device of the present invention.

FIG. 2 is a diagram showing a physical configuration of a connection between an interface on the side of a liquid crystal panel and an interface on the side of the computer.

FIG. 3 is an explanatory diagram of image information (frame).

FIG. 4 is an explanatory diagram of a thinning-out process.

FIG. 5 is an explanatory diagram of a replacing process.

FIG. 6 is an explanatory diagram of the thinning-out process and the replacing process.

FIG. 7 is a schematic diagram when transmitting data signals.

FIG. 8 is an explanatory diagram of a timing signal.

FIG. 9 is an explanatory view of the image information transmitting device and the image information receiving device in a first embodiment.

FIG. 10 is a flowchart showing a processing flow of restoring and displaying the image information.

FIG. 11 is an explanatory view of the image information transmitting device and the image information receiving device in a second embodiment.

FIG. 12 is an explanatory view of the image information transmitting device and the image information receiving device in a third embodiment.

FIG. 13 is an explanatory view of the image information transmitting device and the image information receiving device in a fourth embodiment.

### DETAILED DESCRIPTION OF THE PREFERRED EMBODIMENT

### First Embodiment

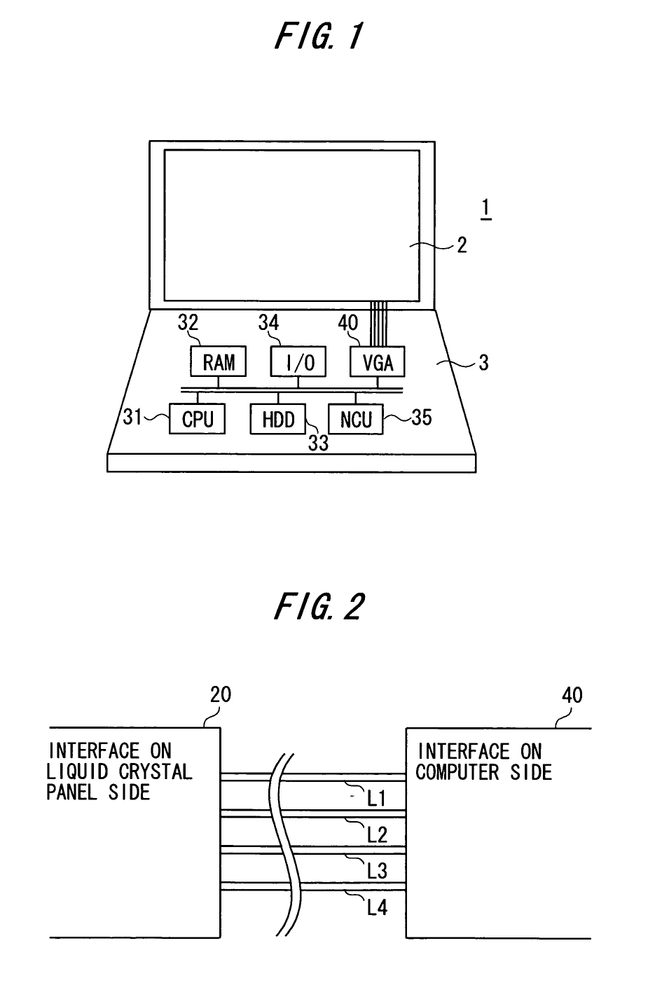

FIG. 1 is a schematic view of a computer including an image information transmission system configured by an image information transmitting device and an image information receiving device according to the present invention.

A computer 1 has a display device (liquid crystal panel) 2 openable and closable with respect to a main body 3. The main body 3 includes a CPU 31, a main memory 32, a storage device (hard disk) 33, an input device (a keyboard, a pointing device, etc) 34, a network control unit (NCU) 35 and an image control unit (corresponding to the image information transmitting device) 40.

The image control unit 40 is a computer-sided interface that transmits the image information to the display device 2, thereby displaying the image information on the display device 2. In the first embodiment, the image control unit 40 transmits, based on an LVDS (Low Voltage Differential Signaling) method, as shown in FIG. 2, the image information to a liquid crystal panel sided interface (the image information receiving device) 20 by use of three pairs of lines L1, L2, L3 for transmitting data signals and a pair of lines L4 for transmitting a clock signal. Herein, the image control unit 40 transmits the image information in a way that reduces an information quantity (data size) while thinning out the data by deleting part of this data with a plurality of gradations that form the image information, thereby enabling speedup or stability.

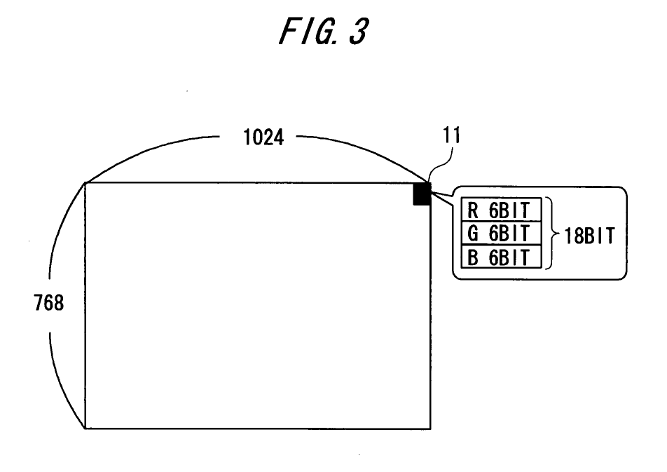

To begin with, a principle of an image information transmitting method of transmitting the image information in a way that reduces the information quantity, will be explained with reference to FIGS. 3 through 6.

The image information has such a structure as to contain values of respective pixels arrayed in a horizontal direction and in a vertical direction thereby to form frames, and timing signals for forming the frames. In the first embodiment, as illustrated in FIG. 3, 1024 pixels 11 are arrayed in the horizontal direction, and 768 pixels 11 are arrayed in the vertical direction, thus forming 1 frame.

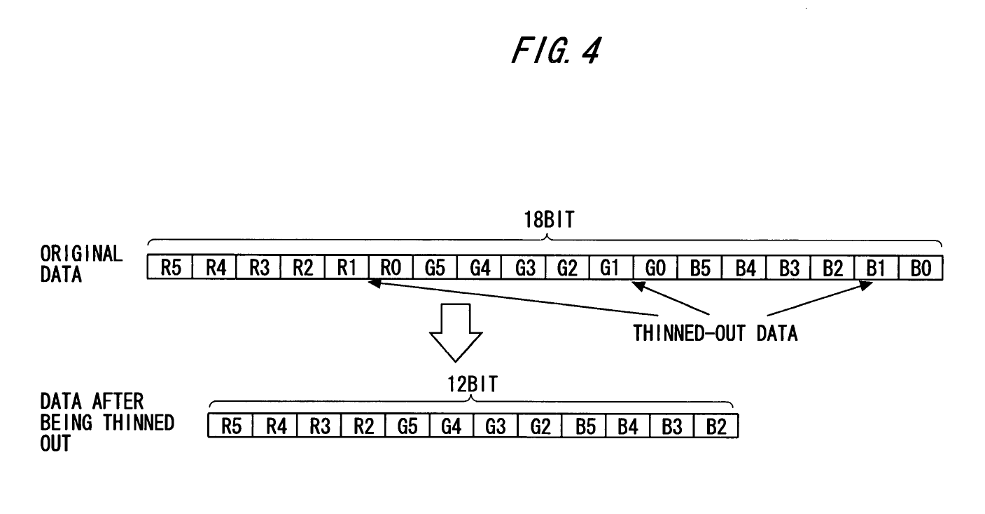

The pixel 11 is depicted in three primary colors (R, G, B) (each having 6 bits in this example) with a plurality of gradations. To be specific, as shown in FIG. 4, data signals per pixel have 18 bits of R0-R5, G0-G5, B0-B5. In those bits, “0” is the least significant bit, while “5” is the most significant bit.

The image control unit 40 in this example, as illustrated in FIG. 4, thins out the original 18-bit data of R0-R5, G0-G5, B0-B5 by deleting the low-order bits (corresponding to low-order data) R0, R1, G0, G1, B0, B1, whereby the image data are reduced down to 12 bits (which will hereinafter be also termed a thinning-out process).

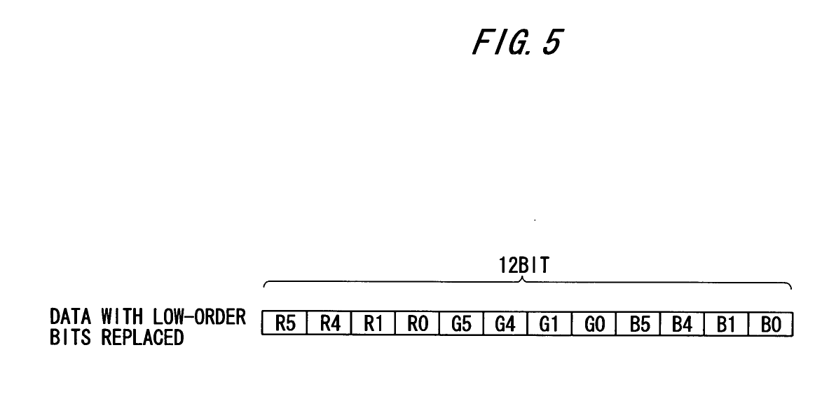

Further, the image control unit 40, as shown in FIG. 5, deletes and replaces part (which will hereinafter be also referred to as intermediate-order bits) of the high-order data with the low-order data for every 15 frames, and thus transmits the data (which will hereinafter be also termed a replacing process).

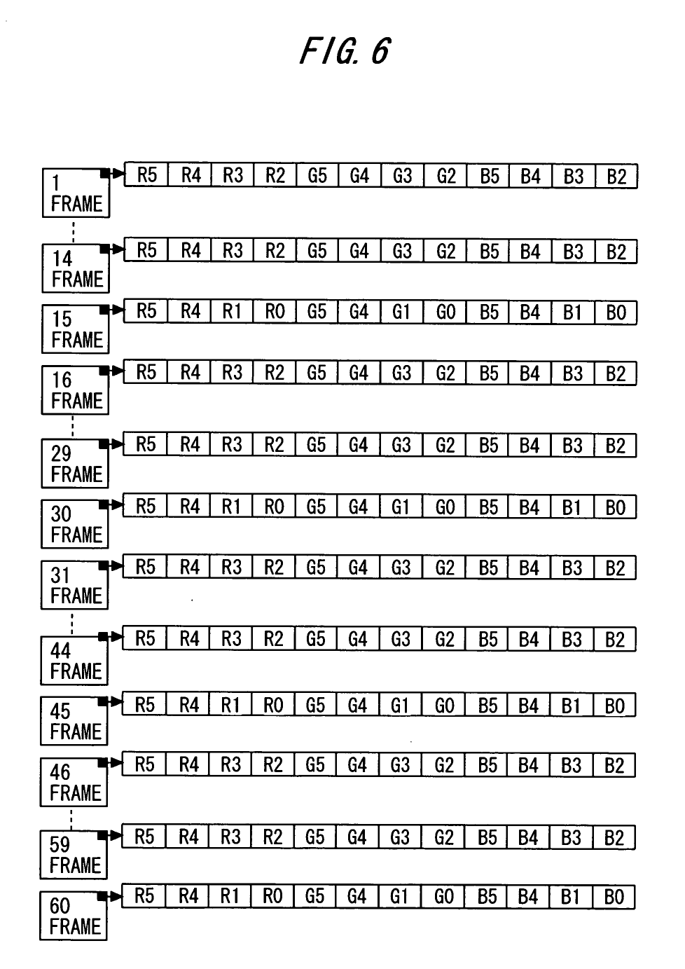

Namely, as illustrated in FIG. 6, the pixels forming the frames ranging from the first frame to fourteenth frame are transmitted as the data of R2, R3, R4, R5, G2, G3, G4, G5, B2, B3, B4, B5 into which the original data are thinned out by the low-order bits of R0, R1, G0, G1, B0, B1. Moreover, the pixels forming the fifteenth frame are transmitted as data of R0, R1, R4, R5, G0, G1, G4, G5, B0, B1, B4, B5 acquired by replacing the intermediate-order bits of R2, R3, G2, G3, B2, B3 with the low-order bits.

Similarly, the pixels ranging from the sixteenth frame to the twenty ninth frame are transmitted as the thinned-out data, the pixels of the thirtieth frame are transmitted as the replaced data, the pixels from the thirty first frame to the forty fourth frame are transmitted as the thinned-out data, the pixels of the forty fifth frame are transmitted as the replaced data, the pixels from the forth sixth frame to the fifty ninth frame are transmitted as the thinned-out data, and the pixels of the sixtieth frame are transmitted as the replaced data. In this example, a frame rate is set to 60 fps, and the processes of the first through sixtieth frames are repeated per second.

Thus, the image control unit 40, when transmitting the data at a predetermined frame rate, repeats the thinning-out process and the replacing process at a predetermined cycle.

On the other hand, the liquid crystal panel sided interface 20 stores the low-order bits of R0, R1, G0, G1, B0, B1 of the pixels of the sixtieth frame, and supplements these low-order bits to the image information (12 bits) ranging from the first frame down to the fourteenth frame, thereby restoring the image information (12 bits) back to the 18-bit data of R0-R5, G0-G5, B0-B5 (which will hereinafter be also referred to as a supplementing process).

Further, the interface 20 adds the intermediate-order bits of the just-anterior frame (the fourteenth frame) to the image information (12 bits) of the fifteenth frame, and replaces the intermediate-order bits with the low-order bits, thereby restoring the data back to the 18-bit data of R0-R5, G0-G5, B0-B5 (which will hereinafter be also termed a re-replacing process).

Similarly, the interface 20 repeats the supplementing process and the re-replacing process at a predetermined cycle (for every 15 frames in this example). Namely, the interface 20 restores the 18-bit image information from the 12-bit image information and displays the restored image information on the liquid crystal panel.

As described above, the image control unit 40 in this example thins out the 18-bit data into 12-bit data and thus transmits the data, and hence a data signal transmission load becomes 12/18.

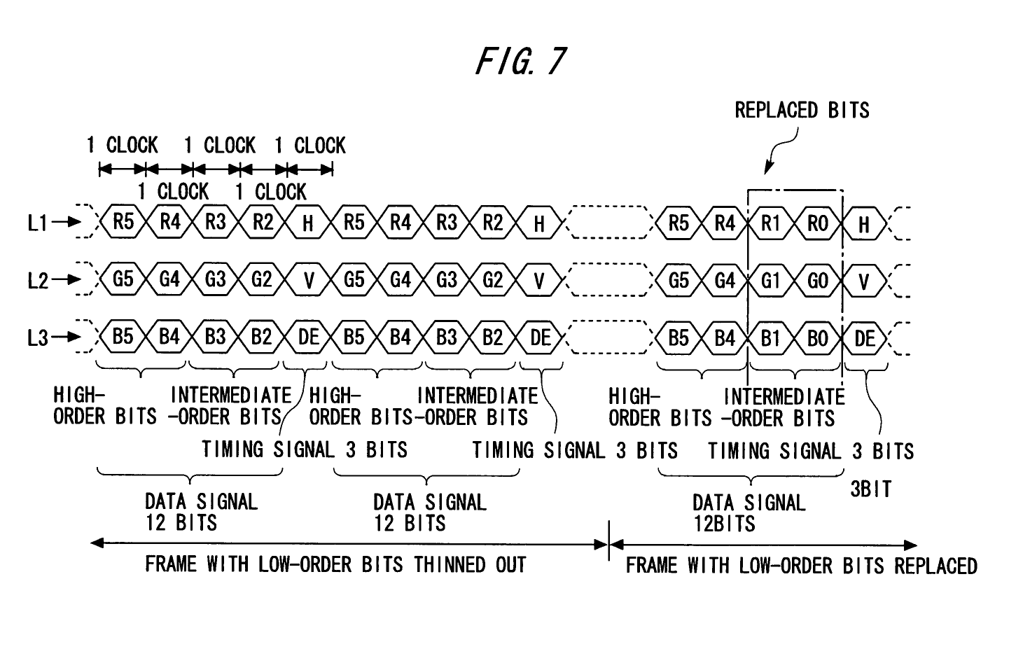

As a matter of fact, the data are transmitted while adding 3-bit timing signals to the 12-bit data signals per pixel. FIG. 7 is a schematic diagram showing a case of transmitting the data signals via the three pairs of lines L1, L2, L3. As illustrated in FIG. 7, the respective bits are transmitted at timings (clocks) determined by clock signals of line L4. Namely, image control unit 40 transmits, with five clocks, the 12-bit data signals and the 3-bit timing signals (at the fifth clock).

Accordingly, in the example in FIG. 7, the image control unit 40, through the lines L1-L3, transmits R5, G5, B5 at the first clock, and transmits R4, G4, B4 at the second clock. Then, in the case of the image information of the frame thinned out by deleting the low-order bits, the image control unit 40 transmits R3, G3, B3 at the third clock, then transmits R2, G2, B2 at the fourth clock, and transmits the timing signals H, V, DE at the fifth clock.

Then, in the case of transmitting the image information of the frame with the low-order bits replaced, the image control unit 40, through the lines L1-L3, transmits R5, G5, B5 at the first clock, transmits R4, G4, B4 at the second clock, transmits R1, G1, B1 at the third clock, transmits R0, G0, B0 at the fourth clock, and transmits the timing signals H, V, DE at the fifth clock. Namely, the image control unit 40 replaces the data to be transmitted at the third through fourth clocks with the low-order bits from the intermediate-order bits (which are indicated by a range delimited by a dot dashed line in FIG. 7).

It is to be noted that though explained for convenience by arranging the bits in the sequence from the high-order to the low-order for every color such as R5, R4, R3, R2, the transmission is not limited to this sequence. The actual transmission sequence is set by taking into consideration a frequency at which each bit switched over to High or Low, an influence of noise, etc.

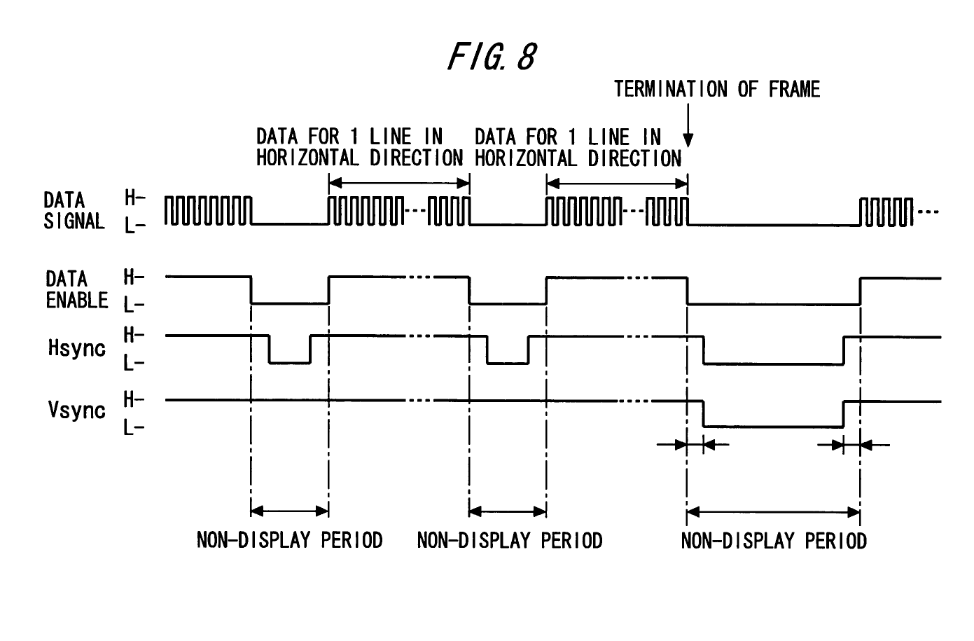

Further, “H” of the timing signal represents a signal (Hsync) for taking synchronization in the horizontal direction, wherein as shown in FIG. 8, “High” is kept for a period during which the data for 1 line in the horizontal direction of frame are transmitted, and “Low” is kept for a predetermined period till the transmission of the data of a next line is started since the transmission of the data for 1 line has been finished.

“V” of the timing signal represents a signal (Vsync) for taking the synchronization in the vertical direction (FIG. 3), wherein “High” is kept for a period during which the data for 1 frame are transmitted, and “Low” is kept for a predetermined period till the transmission the data of a next frame is started since the transmission of the data for 1 frame has been finished.

Then, “DE” of the timing signal represents a signal (Data Enable) showing an existence or non-existence of the data signal. Namely, the signal DE becomes “High” for a period during which the display is conducted and becomes “Low” for a period (non-display period) during which the display is not conducted.

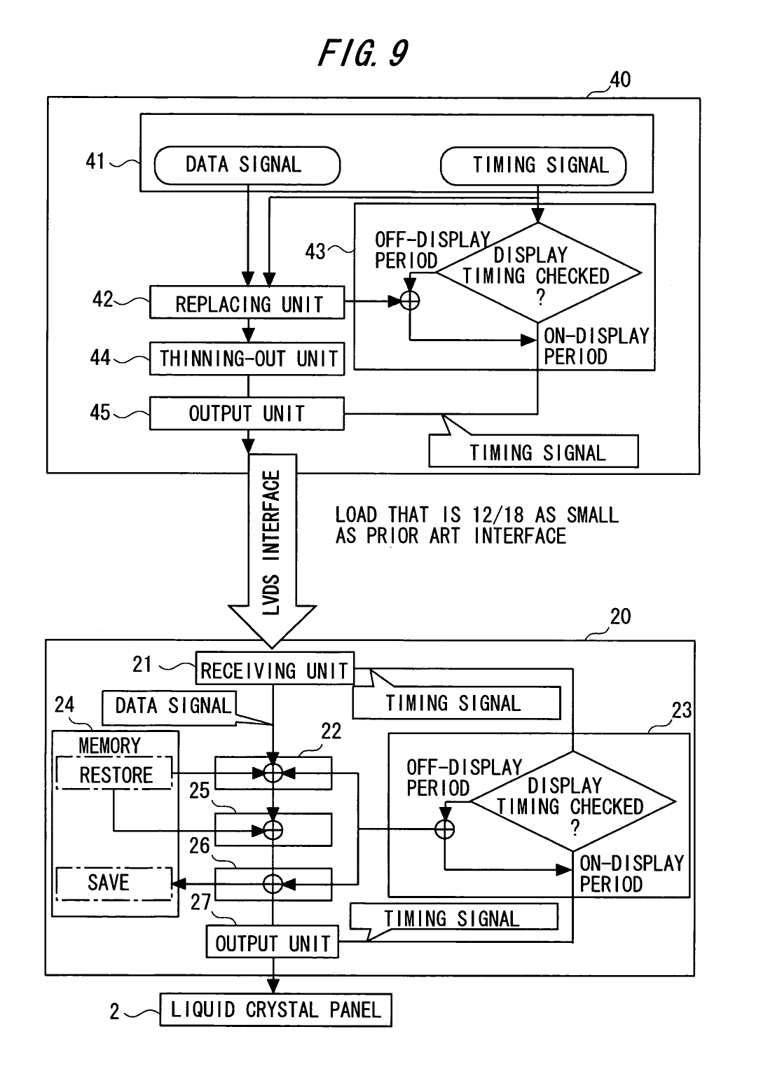

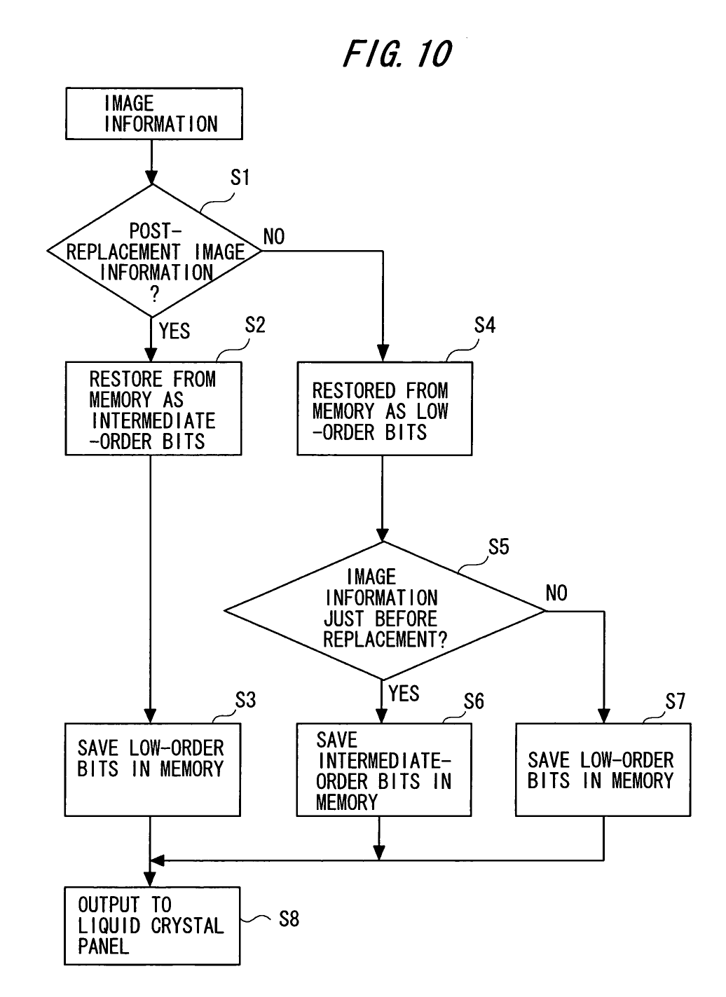

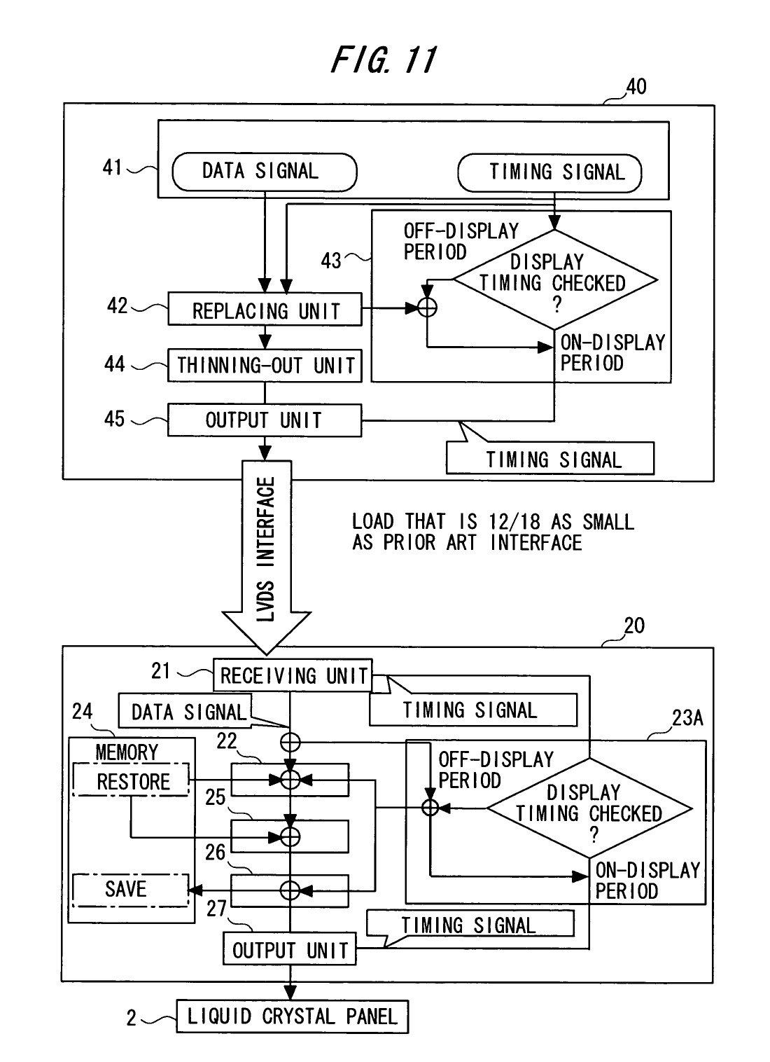

Next, the image control unit 40 and the liquid crystal panel sided interface 20 in the first embodiment will be specifically described with reference to FIGS. 9 and 10.

The image control unit 40 in the first embodiment includes, as illustrated in FIG. 9, an image information generating unit 41, a replacing unit 42, an identification signal generating unit 43, a thinning-out unit 44 and an output unit 45.

The image information generating unit 41 generates the image information on the basis of a display command of a processing result of the CPU 31 etc. The configuration for generating the image information, i.e., the data signals and the timing signals, is widely known, and hence its detailed explanation is omitted.

The replacing unit 42 executes a replacing process of replacing, in the data with the plurality of gradations that form the image information, at least part of the high-order data with the low-order data.

The identification signal generating unit 43 generates pieces of identifying information for identifying the image information after the replacement and the image information just before the replacement.

The thinning-out unit 44 executes the thinning-out process of thinning out the data with the plurality of gradations that form the image information by deleting the low-order data.

The output unit 45 consecutively outputs the image information after being thinned out (which is also referred to as the post-thinning-out image information or the post-thinning-out frame) or the image information after being replaced (which is also termed the post-replacing image information or the post-replacing frame).

Then, the image control unit 40, when the image information generating unit 41 generates the image information on the basis of the display command, judges whether or not the information is the image information (frame) undergoing the replacing process by the replacing unit 42 on the basis of the timing signal of the image information. Further, the replacing unit 42 also judges whether or not the frame is the frame just anterior to the frame subjected to the replacing process. For example, the replacing unit 42 counts the V-signals and, if this count value is a predetermined count value (15, 30, 45, 60 in this example), judges that the frame is the frame subjected to the replacing process. Similarly, the replacing unit 42, if the result of counting (count value) is a value just anterior (14, 29, 44, 59 in this example) to the predetermined count value, judges that it is the frame just anterior to the frame undergoing the replacing process.

When judging that it is the frame just anterior to the frame undergoing the replacing process, for example, when detecting the V-signal serving as a delimiter between the thirteenth frame and the fourteenth frame, the replacing unit 42 notifies the identification signal generating unit 43 of this purport. Similarly, when judging that it is the frame undergoing the replacing process, for example, when detecting the V-signal serving as the delimiter between the fourteenth frame and the fifteenth frame, the replacing unit 42 notifies the identification signal generating unit 43 of this purport.

The identification signal generating unit 43 notified of the purport that it is the frame just anterior to the frame undergoing the replacing process, sends the identifying information specifying the frame concerned in a way that embeds this identifying information into the non-display period timing signal. Similarly, the identification signal generating unit 43 notified of the purport that it is the frame undergoing the replacing process, sends the identifying information specifying the frame concerned in a way that embeds this identifying information into the non-display period timing signal. For instance, the timing signal is, as shown in FIG. 8, such that when the V-signal is “Low”, the H-signal and the DE-signal also become “Low”. Such being the case, in the case of embedding the identifying information purporting that it is the frame just anterior to the frame undergoing the replacing process, both of the DE-signal and the H-signal are set “High” during the “Low” period of the V-signal. Likewise, in the case of embedding the identifying information purporting that it is the frame subjected to the replacing process, only the DE-signal is set “High” during the “Low” period of the V-signal. It is to be noted that without being limited to this scheme, it is sufficient if capable of transmitting the information specifying the frame just anterior to the frame undergoing the replacing process or specifying the frame subjected to the replacing process by use of the non-display period timing signal. For example, at the delimiter of the line in the horizontal direction, during the “Low” period of the H-signal, the DE-signal becomes also “Low”, i.e., becomes a status where “0” continues. During the “Low” period of the H-signal, the identifying information may also be transmitted by changing the DE-signal such as 01, 11. Note that the identification signal generating unit 43 transmits to the output unit 45 the timing signal during the display period and the timing signal during the non-display period of the non-notified frame without any change.

Then, the replacing unit 42, if the result of counting (count value) is not the predetermined count, transmits the data signals to the thinning-out unit 44 without executing the replacing process.

The thinning-out unit 44 thins out, as described above, the 18-bit image information by deleting the low-order 2 bits for every color into the 12-bit image information.

The output unit 45 outputs the data signals after undergoing this thinning-out process and the timing signals via the lines L1-L3 at the timings determined by the clock signals.

On the other hand, the liquid crystal panel sided interface 20 includes a receiving unit 21, a re-replacing unit 22, an identifying information extracting unit 23, a memory 24, a supplementing unit 25, a data extracting unit 26 and an output unit 27.

The receiving unit 21 consecutively receives the image information from the image control unit 40, then transmits the data signals to the re-replacing unit 22, and at the same time transmits the timing signals to the identifying information extracting unit 23.

The re-replacing unit 22 replaces part (the intermediate-order bits) of the high-order data of the post-thinning-out frame received just before the post-replacing frame with the low-order information (low-order bits) by attaching these pieces of data to the post-replacing frame.

The identifying information extracting unit 23 extracts the identifying information from the timing signals and supplies the identifying information to the re-replacing unit 22 and to the data extracting unit 26. Namely, the identifying information extracting unit 23 monitors the non-display period timing signal and, if the timing signal being originally kept at “Low” becomes “High”, extracts this signal as the identifying information. The identifying information specifying the post-replacing frame and the identifying information specifying the frame just before the replacement, are thereby supplied.

The memory 24 is stored with the low-order data (low-order bits) or at least part (intermediate-order bits) of the high-order data, which are extracted by the data extracting unit 26.

The supplementing unit 25 supplements the low-order data extracted from the post-replacing image information to the post-thinning-out image information received subsequently to the post-replacing image information.

The data extracting unit 26 extracts the low-order data of the data signals or at least part of the high-order data of the data signals, and stores the extracted data in the memory 24. In the first embodiment, the low-order 2 bits are extracted for every color. Specifically, in the case of the post-thinning-out frame, the intermediate-order bits of R3, R2, G3, G2, B3, B2 are stored, and, in the case of the post-replacing frame, the low-order bits of R1, R0, G1, G0, B1, B0 are stored.

The output unit 27 outputs the post-supplementing image information and the post-replacing image information to the liquid crystal panel 2, wherein these pieces of image information are displayed on the liquid crystal panel 2.

FIG. 10 is a flowchart showing a processing flow when the liquid crystal panel sided interface 20 restores and outputs the image information.

As shown in FIG. 10, in the interface 20, when receiving the image information through the receiving unit 21, at first the re-replacing unit 22 judges based on the identifying information given from the identifying information extracting unit 23 whether the frame is the post-replacing frame or not (step 1, which will hereinafter be abbreviated such as S1). If judged to be post-replacing frame, the re-replacing unit 22 reads the data stored in the memory 24, and replaces the bits with the low-order bits, thus adding these bits as the intermediate-order bits (S2).

Further, if the re-replacing unit 22 judges in step 1 that the frame is not the post-replacing frame, the supplementing unit 25 reads the data from the memory 24 and supplements the bits as the low-order bits to the data signals (S4).

Then, the data extracting unit 26 extracts the intermediate-order bits or the low-order bits of the data signals on the basis of the identifying information, and stores the extracted bits in the memory 24. Namely, the data extracting unit 26 saves the low-order bits in the memory 24 in the case of the post-replacing frame (S3), then saves the intermediate-order bits in the memory 24 in the case of the frame just before the replacement (S6), and saves the low-order bits in the memory 24 in the case of the frame other than these categories of frames (S7). It is to be noted that if step 3 is surely executed, step 7 may be omitted.

The output unit 27 outputs and displays the post-supplementing frame and the post-replacing frame line by line to and on the liquid crystal panel 2 on the basis of the timing signals (S8).

Thus, according to the first embodiment, it is possible to attain the speedup and the stability by thinning out the image information.

### Second Embodiment

FIG. 11 is a schematic view of the image information transmitting device and the image information receiving device in a second embodiment. The second embodiment is different from the first embodiment discussed above in terms of transmitting the data signals in a way that embeds the identifying information into the data signals. Note that other configurations are the same, and the repetitive explanations are omitted by marking the same components with the same numerals and symbols.

An identifying information generating unit 43A of the image information control unit 40 in the second embodiment, when receiving from the replacing unit 42 notification purporting that the frame is the replacement frame or the frame just before the replacement, generates the identifying information showing this purport and embeds this identifying information into the non-display period data signals, thus transmitting the data signals. For instance, when the DE-signal is at “Low”, the data signals originally become “Low”. Then, when the DE signal is in the non-display period, i.e., the “Low” period, the identifying information is transmitted by setting at “High” the data signals being originally kept in “Low”. For example, in the case of embedding the identifying information showing a purport of being the frame just anterior to the frame undergoing the replacing process, the data signals are set to “1” (High) at the timings of R5 and G5, and, in the case of embedding the identifying information showing a purport of being the frame undergoing the replacing process, the data signals are set to “1” (High) at the timings of B5 and G4. Note that the data signals during the non-display period are changed into a predetermined pattern, whereby the frame just anterior to the frame undergoing the replacing process and the frame undergoing the replacing process, it is sufficient, can be identified.

On the other hand, an identifying information extracting unit 23A of the liquid crystal panel sided interface 20 according to the second embodiment detects based on the timing signal (DE signal) whether the period is the non-display period or not, then monitors the data signals during the non-display period, and, when the data signals being originally kept at “Low” become “High”, extracts this information as the identifying information. The re-replacing unit 22 and the data extracting unit 26 are thereby supplied with the identifying information specifying the post-replacing frame and the identifying information specifying the frame just before the replacement.

The processes of the re-replacing unit 22 and the data extracting unit 26, which have received the identifying information from the identifying information extracting unit 23A, are the same as in the first embodiment discussed above.

Accordingly, even configured to transmit the data signals while embedding the identifying information into the data signals, it is feasible to attain the speedup and the stability on the occasion of transmitting the image information as in the first embodiment discussed above even with the configuration of transmitting the data signals in a way that embeds the identifying information into the data signals.

### Third Embodiment

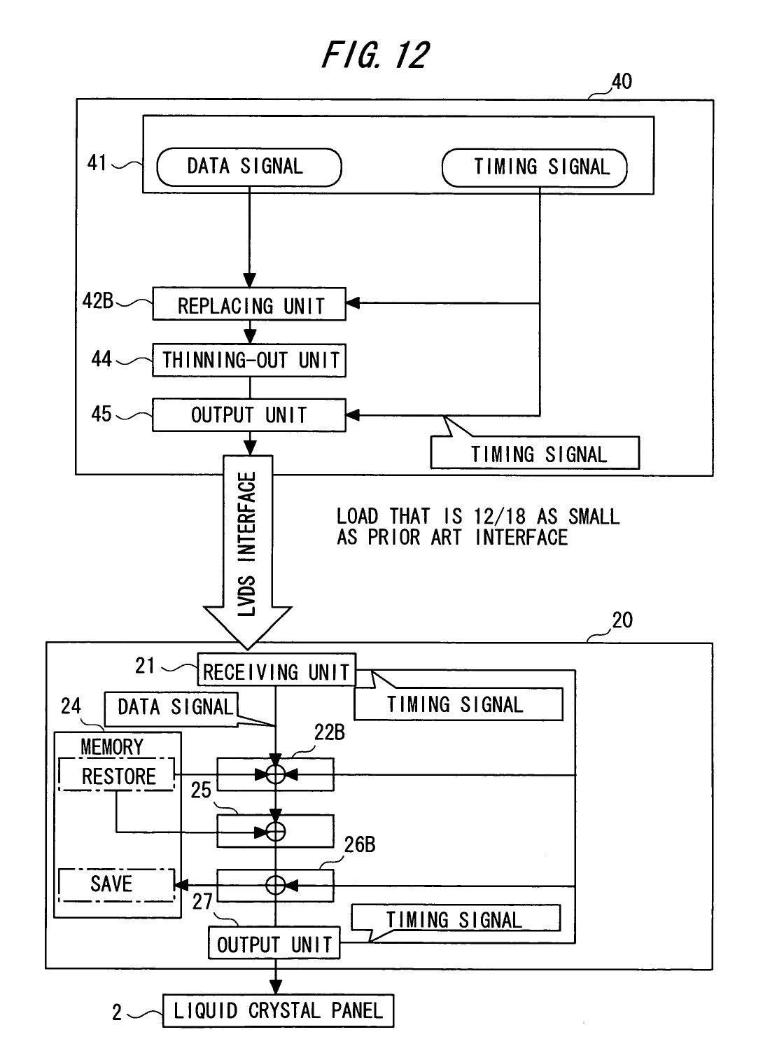

FIG. 12 is a schematic view of the image information transmitting device and the image information receiving device in a third embodiment. The third embodiment is different from the first embodiment discussed above in terms of executing the re-replacing process not based on the identifying information but at a predetermined cycle. Note that other configurations are the same, and the repetitive explanations are omitted by marking the same components with the same numerals and symbols.

The image control unit 40 and the interface 20 in the third embodiment, it is settled, execute the replacing process at a predetermined cycle, e.g., at an interval of 15 frames.

A replacing unit 42B of the image control unit 40 counts the number of frames (frame count) on the basis of the timing signal (e.g., the V-signal), then judges, if the count value is a predetermined count value (15, 30, 45, 60 in this example), that it is the frame subjected to the replacing process, and executes the replacing process.

It is to be noted that the thinning-out process by the thinning-out unit 44 and the output process by the output unit 45 are the same as those in the embodiments discussed above.

Then, the re-replacing unit 22B and a data supplementing unit 26B of the interface 20 each count the frame count on the basis of the data signals, and judge whether the frame is the post-replacing frame or the frame just before the replacement.

In the interface 20 in the third embodiment, as illustrated in FIG. 10, when receiving the image information from the image control unit 40, to start with, the re-replacing unit 22 judges based on the count value of the frame count whether the frame is the post-replacing frame or not (step 1, which will hereinafter be abbreviated such as S1). If judged to be post-replacing frame, the re-replacing unit 22 reads the data stored in the memory 24, and replaces the bits with the low-order bits, thus adding these bits as the intermediate-order bits (S2).

Further, if the re-replacing unit 22 judges in step 1 that the frame is not the post-replacing frame, the supplementing unit 25 reads the data from the memory 24 and supplements the bits as the low-order bits to the data signals (S4).

Then, the data extracting unit 26 extracts the intermediate-order bits or the low-order bits of the data signals on the basis of the count value of the frame count, and stores the extracted bits in the memory 24. Namely, the data extracting unit 26 saves the low-order bits in the memory 24 in the case of the post-replacing frame (S3), then saves the intermediate-order bits in the memory 24 in the case of the frame just before the replacement (S6), and saves the low-order bits in the memory 24 in the case of the frame other than these categories of frames (S7).

The output unit 27 outputs and displays the post-supplementing frame and the post-replacing frame line by line to and on the liquid crystal panel 2 on the basis of the timing signals (S8).

Thus, according to the third embodiment, it is possible to attain the speedup and the stability by thinning out the image information.

### Fourth Embodiment

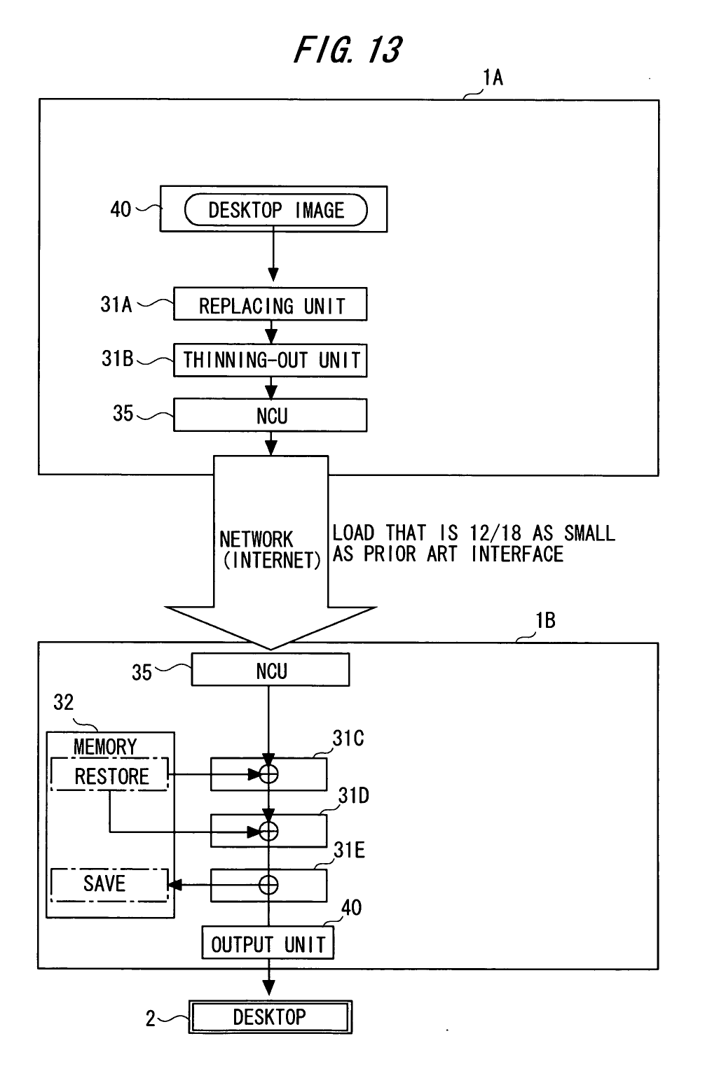

FIG. 13 shows an example where the image information transmitting method of the present invention is applied to communications via a network between computers.

Computers 1A, 1B shown in FIG. 13 are, similarly to the computer illustrated in FIG. 1, computers of a general purpose that have the main body including an arithmetic processing unit constructed of a CPU (Central Processing Unit) 31, a main memory 32, etc, the storage unit (hard disk) 33 stored with data and software for an arithmetic process, input/output ports 34, the network control unit (NCU) 35, the image control unit 40 and so on.

Input devices such as the keyboard, the mouse and a CR-R0M drive, and output devices such as the display device 2 and a printer are properly connected to the input/output ports 34.

The NCU 35 controls the communications with other computers via the network.

The storage unit 33 is preinstalled with operating system (OS) and application software (an image information transmission program).

The arithmetic processing unit properly reads the OS and the application program from the storage unit 33 and executes the OS and the application program, and executes an arithmetic process of information inputted from the input/output ports 34 and from the NCU 35 and of the information read from the storage unit 33, thereby functioning as a replacing unit 31A, a thinning-out unit 31B, a re-replacing unit 31C, a supplementing unit 31D and a data extracting unit 31E.

This replacing unit 31A executes the replacing process of replacing, in the data with the plurality of gradations that form the image information, at least part of the high-order data with the low-order data.

The thinning-out unit 31B executes the thinning-out process of thinning out the data with the plurality of gradations that form the image information by deleting the low-order data.

The re-replacing unit 31C executes the re-replacing process of replacing part (the intermediate-order bits) of the high-order data of the post-thinning-out frame received just before the post-replacing frame with the low-order information (low-order bits) by attaching these pieces of data to the post-replacing frame.

The supplementing unit 31D executes the supplementing process of supplementing the low-order data extracted from the post-replacing image information to the post-thinning-out image information received subsequently to the post-replacing image information.

The data extracting unit 31E extracts the low-order data of the data signals or at least part of the high-order data of the data signals, and stores the extracted data in the memory 32. In the fourth embodiment, the low- or intermediate-order 2 bits are extracted for every color. Specifically, in the case of the post-thinning-out frame, the intermediate-order bits of R3, R2, G3, G2, B3, B2 are stored, and, in the case of the post-replacing frame, the low-order bits of R1, R0, G1, G0, B1, B0 are stored.

The output unit 27 outputs the post-supplementing image information and the post-replacing image information to the liquid crystal panel 2, wherein these pieces of image information are displayed on the liquid crystal panel 2.

The computers 1A, 1B in the fourth embodiment have both of the components of the image information transmitting device and the components of the image information receiving device and have the configuration capable of transmitting and receiving, however, in FIG. 13, for the convenience's sake, the computer 1A used herein is exemplified as the image information transmitting device while the computer 1B employed herein is exemplified as the image information receiving device.

Next, the image information transmitting method between these computers 1A and 1B will be explained.

The computer 1A captures the image information generated by the image information generating unit 41 etc, for example, the information on a desktop image, and the replacing unit 31A counts a frame count of the image information and judges whether or not it is the frame undergoing the replacing process. The count value of this frame count may involve using the timing signal as in the case of the embodiments discussed above, and may also involve counting arbitrary type of information representing delimiters of the frames. For instance, the replacing unit 31A counts the frame count and, if the count value is the predetermined count value (15, 30, 45, 60 in this example), judges that the frame is the frame undergoing the replacing process.

Further, if the result of counting (count value) is not the predetermined count value, the replacing process is not executed, while the thinning-out unit 31B, as illustrated in FIG. 4, thins out the 18-bit image information by deleting the low-order 2 bits for every color into the 12-bit image information.

Then, the NCU 35 transmits the post-replacing process frame and the post-thinning-out process frame to the computer 1B via the network such as the Internet.

In the computer 1B receiving this image information, to begin with, the re-replacing unit 31C counts the frame count, and judges based on the result of counting whether the frame is the post-replacing frame or not (S1). Note that the same processes as those in FIG. 10 are marked with the same step numbers. If being the post-replacing frame, If judged to be post-replacing frame, the re-replacing unit 31C reads the data stored in the memory 32, and replaces the bits with the low-order bits, thus adding these bits as the intermediate-order bits (S2).

Further, if the re-replacing unit 31C judges in step 1 that the frame is not the post-replacing frame, the supplementing unit 31D reads the data from the memory 32 and supplements the bits as the low-order bits to the data signals (S4).

Then, the data extracting unit 26 counts the frame count and extracts the intermediate-order bits or the low-order bits of the data signals on the basis of the result of counting, and stores the extracted bits in the memory 32. Namely, the data extracting unit 26 saves the low-order bits in the memory 32 in the case of the post-replacing frame (S3), then saves the intermediate-order bits in the memory 32 in the case of the frame just before the replacement (S6), and saves the low-order bits in the memory 32 in the case of the frame other than these categories of frames (S7).

The image control unit 40 outputs and displays the post-supplementing frame and the post-replacing frame to and on the liquid crystal panel 2 (S8).

Thus, according to the fourth embodiment, it is possible to reduce the data signals transmitted via the network down to 12/18 and to attain the speedup and the stability.

<Others>

The present invention is not limited to only the illustrated examples given above and can be, as a matter of course, changed in a variety of forms in the range that does not deviate from the gist of the present invention.

<Incorporation by Reference>

The disclosures of Japanese patent application No. JP2006-094118 filed on Mar. 30, 2006 including the specification, drawings and abstract are incorporated herein by reference.

What is claimed is:

1. An image information transmitting device comprising:
a replacing unit replacing, in data with a plurality of gradations that form image information, at least part of high-order data with low-order data;
a thinning-out unit thinning out the data with the plurality of gradations that form the image information by deleting the low-order data; and
an output unit consecutively outputting the post-thinning-out image information or the post-replacing image information.

2. An image information transmitting device according to claim 1, wherein the replacing unit replaces, in the consecutive pieces of image information, the image information delimited at a predetermined cycle.

3. An image information transmitting device according to claim 1, further comprising:
an identifying information generating unit generating a piece of identifying information for identifying the post-replacing image information,
wherein the output unit outputs the identifying information together with the image information.

4. An image information transmitting device according to claim 3, wherein the output unit outputs the identifying information in place of the data with the plurality of gradations during a non-display period.

5. An image information transmitting device according to claim 3, wherein the output unit outputs, in the case of outputting, as the image information, the data with the plurality of gradations and a timing signal, the identifying information in place of the timing signal during the non-display period.

6. An image information receiving device comprising:
a receiving unit consecutively receiving post-replacing image information obtained by replacing at least part of high-order data with low-order data in data with a plurality of gradations that form image information, or post-thinning-out image information obtained by thinning out the data with the plurality of gradations that form the image information by deleting the low-order data;
a data extracting unit extracting the low-order data from the post-replacing image information;
a supplementing unit supplementing the low-order data extracted from the post-replacing image information to the post-thinning-out image information received after the post-replacing image information;
a re-replacing unit replacing at least part of the high-order data of the post-thinning-out image information received just before the post-replacing image information with the low-order information in the way of being attached to the post-replacing image information; and
an output unit outputting the post-supplementing image information and the post-replacing image information.

7. An image information receiving device according to claim 6, wherein the re-replacing unit replaces the image information delimited at a predetermined cycle in the consecutively-received image information.

8. An image information receiving device according to claim 6, wherein the re-replacing unit makes the replacement on the basis of identifying information for identifying the post-replacing image information.

9. An image information receiving device according to claim 8, wherein the receiving unit receives the identifying information in place of the data with the plurality of gradations during a non-display period.

10. An image information receiving device according to claim 8, wherein the receiving unit receives, in the case of receiving, as the image information, the data with the plurality of gradations and a timing signal, the identifying information in place of the timing signal during the non-display period.

11. An image information transmitting method by which an image information transmitting device executes steps of:
replacing, in data with a plurality of gradations that form image information, at least part of high-order data with low-order data;
thinning out the data with the plurality of gradations that form the image information by deleting the low-order data; and
consecutively outputting the post-thinning-out image information or the post-replacing image information.

12. An image information transmitting method according to claim 11, wherein the data replacing step includes replacing, in the consecutive pieces of image information, the image information delimited at a predetermined cycle.

13. An image information transmitting method according to claim 11, further comprising:
a step of generating a piece of identifying information for identifying the post-replacing image information,
wherein the image information outputting step includes outputting the identifying information together with the image information.

14. An image information transmitting method according to claim 13, wherein the image information outputting step includes outputting the identifying information in place of the data with the plurality of gradations during a non-display period.

15. An image information transmitting method according to claim 13, wherein the image information outputting step includes outputting, in the case of outputting, as the image information, the data with the plurality of gradations and a timing signal, the identifying information in place of the timing signal during the non-display period.

16. An image information receiving method comprising steps of:
consecutively receiving post-replacing image information obtained by replacing at least part of high-order data with low-order data in data with a plurality of gradations that form image information, or post-thinning-out image information obtained by thinning out the data with the plurality of gradations that form the image information by deleting the low-order data;
extracting the low-order data from the post-replacing image information;
supplementing the low-order data extracted from the post-replacing image information to the post-thinning-out image information received after the post-replacing image information;
replacing at least part of the high-order data of the post-thinning-out image information received just before the post-replacing image information with the low-order information in the way of being attached to the post-replacing image information; and
outputting the post-supplementing image information and the post-replacing image information.

17. An image information receiving method according to claim 16, wherein the data replacing step includes replacing the image information delimited at a predetermined cycle in the consecutively-received image information.

18. An image information receiving method according to claim 16, wherein the replacement is made based identifying information for identifying the post-replacing image information.

19. An image information receiving method according to claim 18, wherein the image information receiving step includes receiving the identifying information in place of the data with the plurality of gradations during a non-display period.

20. An image information receiving method according to claim 18, wherein the image information receiving step includes receiving, in the case of receiving, as the image information, the data with the plurality of gradations and a timing signal, the identifying information in place of the timing signal during the non-display period.

21. A recording medium recorded with an image information transmitting program for making an image information transmitting device execute steps of:
replacing, in data with a plurality of gradations that form image information, at least part of high-order data with low-order data;
thinning out the data with the plurality of gradations that form the image information by deleting the low-order data; and
consecutively outputting the post-thinning-out image information or the post-replacing image information.

22. A recording medium according to claim 21, wherein the data replacing step includes replacing, in the consecutive pieces of image information, the image information delimited at a predetermined cycle.

23. A recording medium according to claim 21, further comprising:
a step of generating a piece of identifying information for identifying the post-replacing image information,
wherein the image information outputting step includes outputting the identifying information together with the image information.

24. A recording medium according to claim 23, wherein the image information outputting step includes outputting the identifying information in place of the data with the plurality of gradations during a non-display period.

25. A recording medium according to claim 23, wherein the image information outputting step includes outputting, in the case of outputting, as the image information, the data with the plurality of gradations and a timing signal, the identifying information in place of the timing signal during the non-display period.

26. A recording medium recorded with an image information receiving program comprising steps of:
consecutively receiving post-replacing image information obtained by replacing at least part of high-order data with low-order data in data with a plurality of gradations that form image information, or post-thinning-out image information obtained by thinning out the data with the plurality of gradations that form the image information by deleting the low-order data;
extracting the low-order data from the post-replacing image information;
supplementing the low-order data extracted from the post-replacing image information to the post-thinning-out image information received after the post-replacing image information;
replacing at least part of the high-order data of the post-thinning-out image information received just before the post-replacing image information with the low-order information in the way of being attached to the post-replacing image information; and
outputting the post-supplementing image information and the post-replacing image information.

27. A recording medium according to claim 26, wherein the data replacing step includes replacing the image information delimited at a predetermined cycle in the consecutively-received image information.

28. A recording medium according to claim 26, wherein the replacement is made based identifying information for identifying the post-replacing image information.

29. A recording medium according to claim 28, wherein the image information receiving step includes receiving the identifying information in place of the data with the plurality of gradations during a non-display period.

30. A recording medium according to claim 28, wherein the image information receiving step includes receiving, in the case of receiving, as the image information, the data with the plurality of gradations and a timing signal, the identifying information in place of the timing signal during the non-display period.
